(19) United States
(12) Patent Application Publication
(10) Pub. No.: US 2022/0213671 A1
(43) Pub. Date: Jul. 7, 2022

(54) Atmospheric Water Generator

(71) Applicant: Joseph Baruch, Palm City, FL (US)

(72) Inventor: Joseph Baruch, Palm City, FL (US)

(21) Appl. No.: 17/142,939

(22) Filed: Jan. 6, 2021

(51) Int. Cl. E03B 3/28

(52) U.S. Cl. CPC E03B 3/28; C02F 1/001

(57) ABSTRACT

The present invention is directed to an atmospheric water generator (AWG) with enhanced water extraction capability. The apparatus is part of a heating or cooling unit, which unit may be either mobile or stationary. Water diverting and funneling is used to collect rainwater in the reservoir of the apparatus. In order to increase the moisture extraction rate, outside air is passed through an additional evaporator coil having a higher effective surface area than a standard evaporator coil. Additional moisture is extracted from the ambient air by providing a second evaporator coil to humidify the incoming air to a higher dew point to provide more moisture for the enhanced evaporator coil to extract. Water extracted from the environment is stored in the reservoir, and is filtered before passing to an outlet.

### 1. FIELD OF THE INVENTION

The present invention relates to water generation devices. More particularly, the invention discloses an atmospheric water generation device capable of providing filtered drinking water.

### BACKGROUND OF THE INVENTION

Atmospheric water generators for extracting water from the ambient air are known. Most of these devices use some type of condenser to extract moisture from the water vapor in the local environment. The problem with prior art atmospheric water generators (AWGs) is that they are primarily used for heating and cooling, or are derived from, e.g. AC units. Accordingly, they are more proficient performing the task for which they were designed than generating water.

The present invention is directed to an atmospheric water generator (AWG) with enhanced water extraction capability. The apparatus is part of a heating or cooling unit, which unit may be either mobile or stationary. Water diverting and funneling is used to collect rainwater in the reservoir of the apparatus. In order to increase the moisture extraction rate, outside air is passed through an additional evaporator coil having a higher effective surface area than a standard evaporator coil. Additional moisture is extracted from the ambient air by providing a second evaporator coil to humidify the incoming air to a higher dew point to provide more moisture for the enhanced evaporator coil to extract. Water extracted from the environment is stored in the reservoir, and is filtered before passing to an outlet.

### SUMMARY OF THE INVENTION

It is a major object of the invention to provide an atmospheric water generator.

It is another object of the invention to provide an atmospheric water generator that has both heating and cooling function. It is another object of the invention to provide an atmospheric water generator that includes a funnel for collecting rainwater.

It is another object of the invention to provide an atmospheric water generator having filtration.

It is another object of the invention to provide an atmospheric water generator having enhanced water extraction capability.

### BRIEF DESCRIPTION OF THE DRAWINGS

FIG. 1 shows a diagram of the components of the water generator apparatus of the invention.

FIG. 2 shows a perspective view of the housing of the water generator apparatus of the invention.

FIG. 3 shows a perspective view, partly in section, of the housing of the water generator apparatus of the invention.

### DETAILED DESCRIPTION

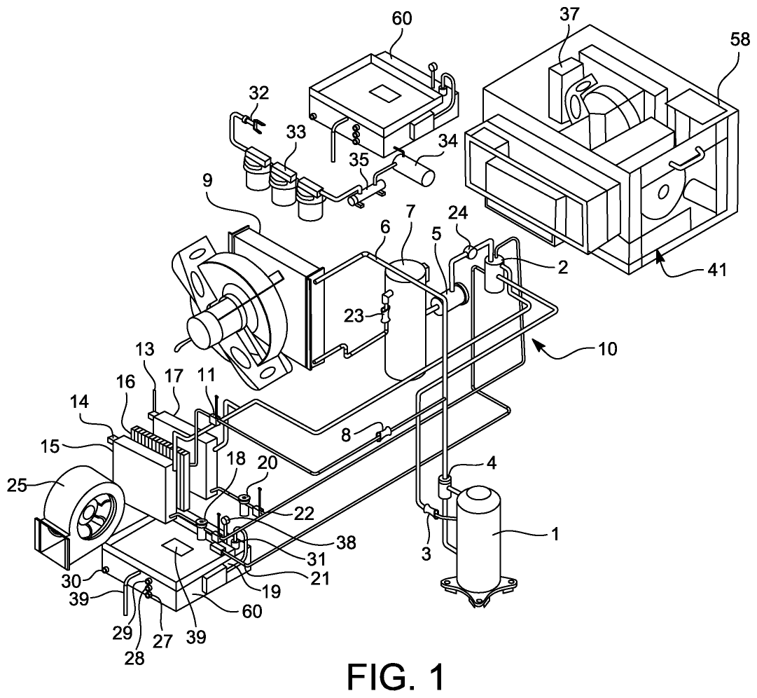

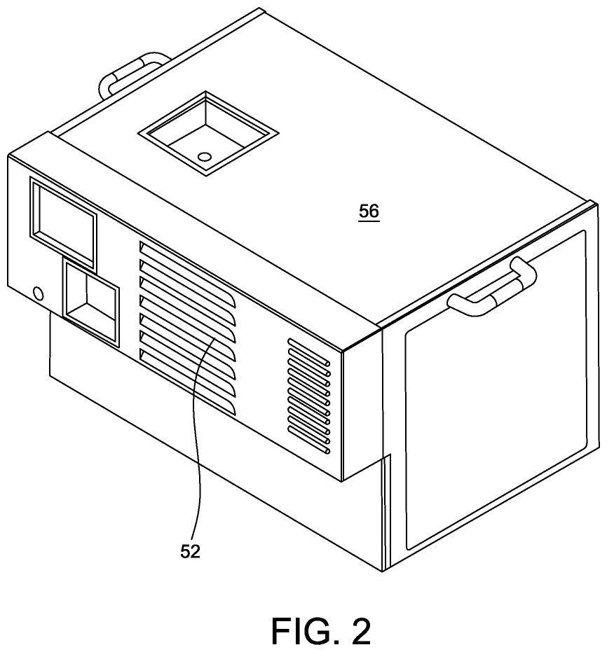

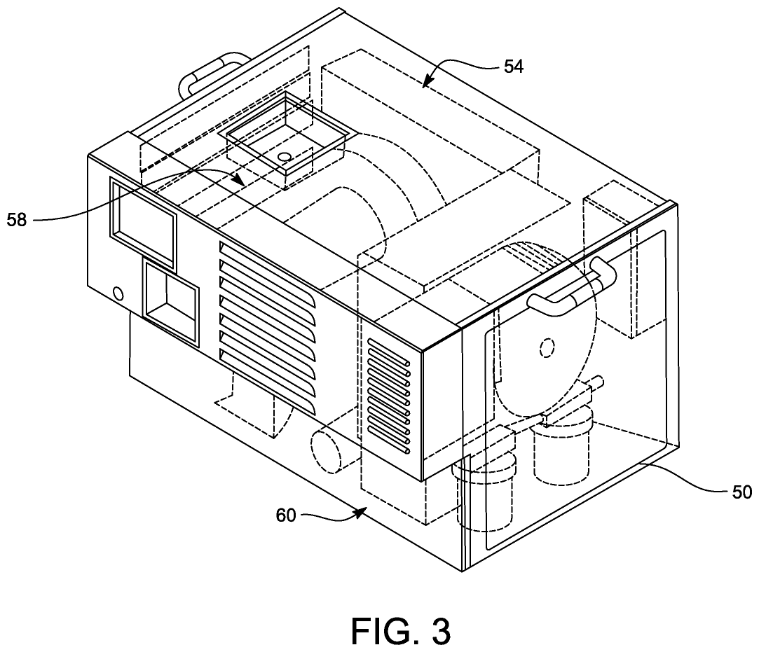

Referring now to FIGS. 1-3, an illustration of the inventive apparatus is shown. The apparatus, generally indicated by the numeral 10, is a heating/cooling unit having enhanced water extraction capabilities, the apparatus 10. The unit can function as both a heating and cooling unit by reversing the cycle in the well known manner.

The apparatus is contained within a housing 50 which may be made from metal or rigid plastic or both. The housing 50 includes output vents 52 for outputting heated/cooled air into a room, and exhaust vents 54 for discharging heated air to the outside. Rainwater falling onto the housing 50 is directed by the slightly sloped top panel 56 into a funnel 58 which drains into reservoir 60, which also receives water from the extraction process which is described in detail below.

A key aspect of the invention is the enhanced water extraction capability. To that end, a high efficiency evaporator coil arrangement is used, along with a second condenser coil which pre-treats the incoming air to add humidity, which in turn increases the amount of water generated by the apparatus 10 by increasing the amount of moisture in the ambient air. FIG. 1 shows an interior of an air conditioning/dehumidifying arrangement modified in accordance with the inventive concept, wherein a compressor 1 compresses a refrigerant such as a chlorofluorocarbon, hydrochlorofluorocarbon, or hydrofluorocarbon, in gas form and pumps it through a first set of condenser coils 9, where the gas heats and becomes a liquid, with the condenser coils 9 dissipating the heat which is exhausted through vents 54. This is a standard arrangement. Refrigerant liquid passes through expansion valves 18, 20 and into evaporator coils 15 and 17, where the refrigerant expands into a gas, thereby dropping in temperature and cooling the evaporator coils 15, 17 before returning to the compressor. The expansion valves 18, 20 provide dynamic resistance and flow control over the amount of refrigerant released into the evaporators 15, 17.

The enhanced water extraction capability is primarily achieved by the inventive evaporator arrangement. Evaporator 15 is a treated microfin evaporator formed of two rows of coils. Air is taken in by an air fan 25, which then pushes the air over the cold evaporator coils 15, 17 to lower the air temperature and effect condensation of the airborne water vapor into liquid water which drains into reservoir 60, which reservoir is made of food grade stainless steel. Additional water is extracted from the air by positioning a second set of condenser coils 16 between evaporator coils 15, 17. These condenser coils 16 serve to increase the humidity of the air around the evaporator coils to increase the amount of water that can be extracted. To operate in heating mode, the evaporator coil 15 is operated in heating mode via microprocessor 37 control. Air passing over the coil 15 will then be heated, with cool air forced out through vents 54.

Water from evaporators 15, 17 drains into reservoir 60 through filter 39. The water from reservoir 60 is filtered before passing to the outlet or spigot 41 where it can be accessed by the user. Filtering of the water is accomplished by providing a particulate filter 33 in series with a UV light chamber 35 along the outlet conduit 62. The particulate filter 33 is preferably a white charcoal/carbon water type of filter. Water is pumped to the spigot 41 via a water pump 35 that is activated when a predetermined amount of water is in the reservoir 60, and the user operates the spigot 41 to extract water. The amount of water in the reservoir 60 is sensed by a sensor 32 which sends control signals to microprocessor 37. An overflow drain 39 will allow the water in reservoir 60 to drain to the exterior of the units via a drain hole in the unit 10 housing.

The microprocessor 37 also receives signals from 3 sensors in order to effect operation of the water generator 10. An intake sensor 14 is used to measure the temperature of the incoming air, and control the duty cycle of the compressor 1 in order to achieve a desired set temperature. A signal corresponding to the temperature of the output air is provided by another sensor (not shown), and a dew point sensor 12 is used to measure the local humidity so that the amount of water generated can be known.

It is to be understood that the present invention is not limited to the sole embodiment described above, but encompasses any and all embodiments within the scope of the following claims:

I claim:

1.
